(19) United States
(12) Patent Application Publication
(10) Pub. No.: US 2026/0175607 A1
(43) Pub. Date: Jun. 25, 2026

(54) PRINTING APPARATUS AND ELECTRONIC DEVICE

(71) Applicant: SEIKO EPSON CORPORATION, Tokyo (JP)

(72) Inventors: Kyo HORIE, Okaya (JP); Koichi KASHU, Shiojiri (JP); Toru MATSUYAMA, Matsumoto (JP)

(21) Appl. No.: 19/430,386

(22) Filed: Dec. 23, 2025

(30) Foreign Application Priority Data
Dec. 25, 2024 (JP) 2024-228605

(51) Int. Cl. B41J 29/393; B41J 2/045; B41J 3/36

(52) U.S. Cl. CPC B41J 29/393; B41J 2/04541; B41J 2/04581; B41J 3/36

(57) ABSTRACT

A printing apparatus includes a print head configured to form an image on a medium based on a control signal, a communication substrate provided with a communication circuit that receives image information indicating the image by wireless communication, a control substrate provided with a control circuit that generates the control signal based on the image information, and a coupling component configured to couple the communication substrate to the control substrate, in which the communication substrate is supported on the control substrate by a clay-like support column with an electrical insulation property.

The present application is based on, and claims priority from JP Application Serial Number 2024-228605, filed Dec. 25, 2024, the disclosure of which is hereby incorporated by reference herein in its entirety.

### BACKGROUND

### 1. Technical Field

The present disclosure relates to a printing apparatus and an electronic device.

### 2. Related Art

Recently, a printing apparatus including a communication circuit for performing wireless communication has been supplied. In such a printing apparatus, for example, there may be a case where it is necessary to remove a communication substrate provided with a communication circuit from the printing apparatus. Accordingly, various proposals have been made for a printing apparatus that can remove the communication substrate from the printing apparatus of the related art. For example, JP-A-2022-157499 discloses a printing apparatus which can remove a communication substrate from the printing apparatus by coupling the communication substrate to a control substrate, which is a substrate on a main body of the printing apparatus, through a detachable coupling component such as a connector.

However, when a communication substrate and a control substrate are coupled to each other by a coupling component such as a connector, a change in relative position or posture between the communication substrate and the control substrate may occur due to vibration or the like of a printing apparatus. When a change in relative position or posture between a communication substrate and a control substrate occurs, surface damage may occur between the communication substrate and a coupling component and between the control substrate and the coupling component. Due to the surface damage between the communication substrate and the coupling component and between the control substrate and the coupling component, fragments are separated from a part or all of the communication substrate, the control substrate, and the coupling component, and a defect may occur in a printing apparatus due to the separated fragments. The defect may occur in not only a printing apparatus but also an electronic device provided with a communication substrate.

### SUMMARY

According to an aspect of the present disclosure, a printing apparatus includes a print head configured to form an image on a medium based on a control signal, a communication substrate provided with a communication circuit that receives image information indicating the image by wireless communication, a control substrate provided with a control circuit that generates the control signal based on the image information, and a coupling component configured to couple the communication substrate to the control substrate, in which the communication substrate is supported on the control substrate by a clay-like support column with an electrical insulation property.

In addition, according to another aspect of the present disclosure, an electronic device includes a drive device driven based on a control signal, a communication substrate provided with a communication circuit that receives instruction information on an operation of the drive device by wireless communication, a control substrate provided with a control circuit that generates the control signal based on the instruction information, and a coupling component configured to couple the communication substrate to the control substrate, in which the communication substrate is supported on the control substrate by a clay-like support column with an electrical insulation property.

### BRIEF DESCRIPTION OF THE DRAWINGS

FIG. 1 is a perspective view illustrating an example of a schematic external configuration of an ink jet printer according to a first embodiment of the present disclosure.

FIG. 2 is a perspective view illustrating an example of a schematic external configuration of an ink jet printer.

FIG. 3 is a block diagram illustrating an example of a configuration of an ink jet printer.

FIG. 4 is a perspective view illustrating an example of a schematic internal structure of an ink jet printer.

FIG. 5 is a cross-sectional view illustrating an example of a structure of an ejection portion.

FIG. 6 is a block diagram illustrating an example of a configuration of a head unit.

FIG. 7 is a timing chart illustrating an example of a signal supplied to a head unit.

FIG. 8 is an explanatory diagram illustrating an example of an individual designation signal.

FIG. 9 is a block diagram illustrating an example of a configuration of a drive signal generation circuit.

FIG. 10 is an exploded perspective view illustrating an example of a structure of a drive control unit and a wireless communication unit.

FIG. 11 is a cross-sectional view illustrating an example of a structure of a drive control unit and a wireless communication unit.

FIG. 12 is a schematic view illustrating an example of a support column.

FIG. 13 is a cross-sectional view illustrating an example of a structure of an ink jet printer according to a comparative example.

FIG. 14 is a perspective view illustrating an example of a schematic external configuration of a smartphone according to a second embodiment of the present disclosure.

FIG. 15 is a block diagram illustrating an example of a configuration of a smartphone.

FIG. 16 is a cross-sectional view illustrating an example of a structure of a smartphone.

FIG. 17 is a cross-sectional view illustrating an example of a structure of an ink jet printer according to a modification example of the present disclosure.

### DESCRIPTION OF EMBODIMENTS

Hereinafter, embodiments for carrying out the present disclosure will be described with reference to the drawings. Meanwhile, dimensions and scales of respective portions are different from actual dimensions and scales as appropriate in respective drawings. In addition, embodiments to be described below are preferred specific examples of the present disclosure and are added with technically preferred various limitations, but the scope of the present disclosure is not limited to such embodiments unless description for limiting the present disclosure is made in the following description.

### A. First Embodiment

In the first embodiment, a printing apparatus will be described by exemplifying an ink jet printer 1 that ejects ink to form an image on recording paper PP.

### A.1. Overview of Ink Jet Printer 1

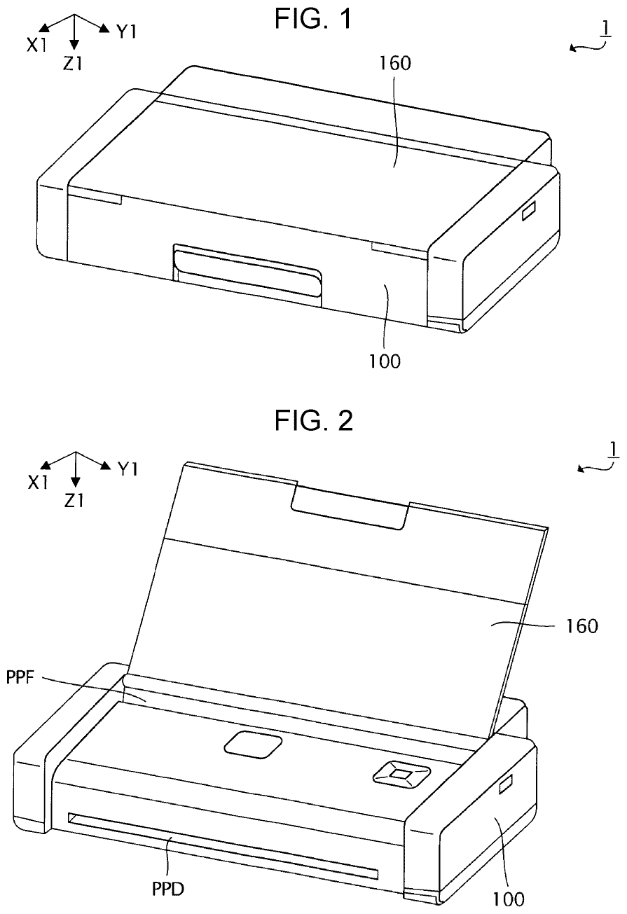

Hereinafter, an example of a configuration of the ink jet printer 1 according to the first embodiment will be described with reference to FIGS. 1 to 5.

FIGS. 1 and 2 are external perspective views illustrating an example of an appearance of the ink jet printer 1.

As illustrated in FIGS. 1 and 2, the ink jet printer 1 is a mobile printer that can be carried by a user of the ink jet printer 1, and includes a housing 100, an openable/closable cover member 160, a paper feed port PPF for supplying the recording paper PP to the inside of the ink jet printer 1, and a paper discharge port PPD for discharging the recording paper PP from the ink jet printer 1.

Hereinafter, a front surface direction of the ink jet printer 1 is referred to as an X1 direction, a rear surface direction of the ink jet printer 1 is referred to as an X2 direction, and the X1 direction and the X2 direction are collectively referred to as an X-axis direction. In addition, when the ink jet printer 1 is viewed in the X2 direction, a right direction of the ink jet printer 1 is referred to as a Y1 direction, a left direction of the ink jet printer 1 is referred to as a Y2 direction, and the Y1 direction and the Y2 direction are collectively referred to as a Y-axis direction. In addition, a downward direction of the ink jet printer 1 is referred to as a Z1 direction, an upward direction is referred to as a Z2 direction, and the Z1 direction and the Z2 direction are collectively referred to as a Z-axis direction. In the present embodiment, as an example, description will be made by assuming that the X-axis direction, the Y-axis direction, and the Z-axis direction are orthogonal to each other. Meanwhile, the present disclosure is not limited to such an aspect. The X-axis direction, the Y-axis direction, and the Z-axis direction may intersect each other.

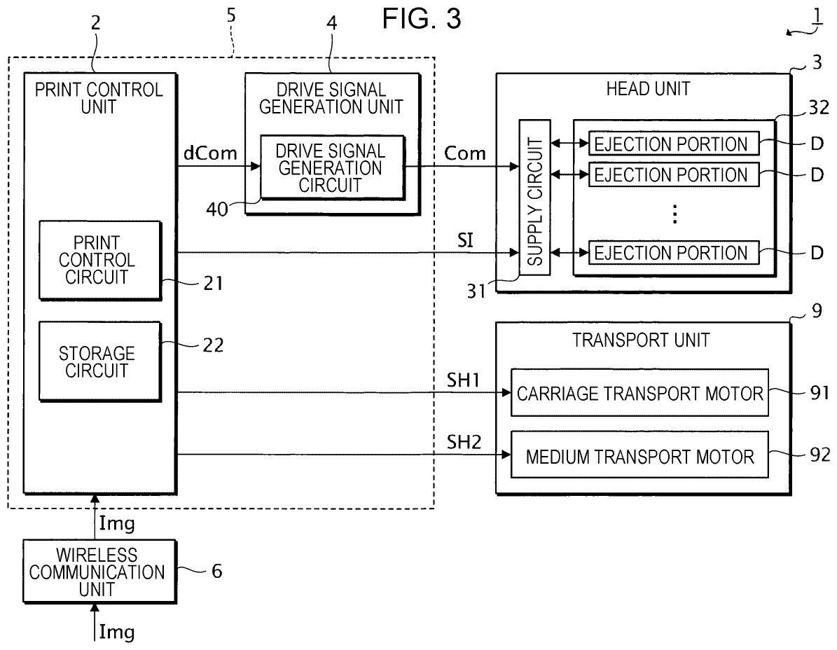

FIG. 3 is a functional block diagram illustrating an example of a configuration of the ink jet printer 1.

As illustrated in FIG. 3, the ink jet printer 1 is supplied with image data Img indicating an image to be formed by the ink jet printer 1 from a host computer such as a personal computer or a digital camera. The ink jet printer 1 performs print processing of forming an image, which is indicated by the image data Img supplied from a host computer, on the recording paper PP.

As illustrated in FIG. 3, the ink jet printer 1 includes a print control unit 2 that controls each portion of the ink jet printer 1, a head unit 3 provided with an ejection portion D that ejects ink to the recording paper PP, a drive signal generation unit 4 provided with a drive signal generation circuit 40 that generates a drive signal Com for driving the ejection portion D, a wireless communication unit 6 that acquires the image data Img by wireless communication, and a transport unit 9 for transporting the head unit 3 and the recording paper PP.

In the present embodiment, the ink jet printer 1 is an example of a “printing apparatus” and an “electronic device”, the head unit 3 is an example of a “print head” and a “drive device”, the image data Img is an example of “image information” and “instruction information”, the recording paper PP is an example of a “medium”, and the transport unit 9 is an example of a “transport mechanism”. In addition, hereinafter, a configuration including the print control unit 2 and the drive signal generation unit 4 is referred to as a “drive control unit 5”.

In the present embodiment, a case is assumed where the ink jet printer 1 includes one or a plurality of head units 3. Specifically, in the present embodiment, as an example, a case is assumed where the ink jet printer 1 includes four head units 3. Hereinafter, for the sake of convenience of description, there may be a case where one head unit 3 among the four head units 3 is focused on to be described as illustrated in FIG. 3.

In addition, in the present embodiment, as an example, a case is assumed where the drive signal generation unit 4 includes one drive signal generation circuit 40 corresponding to one head unit 3. That is, in the present embodiment, a case is assumed where the drive signal generation unit 4 includes four drive signal generation circuits 40 corresponding to four head units 3. Meanwhile, the present disclosure is not limited to such an aspect. The drive signal generation unit 4 may include two or more drive signal generation circuits 40 corresponding to one head unit 3. Hereinafter, for the sake of convenience of description, there is a case where one drive signal generation circuit 40 among the four drive signal generation circuits 40 is focused on to be described as illustrated in FIG. 3.

The print control unit 2 is configured to include a print control circuit 21 and a storage circuit 22.

The storage circuit 22 is configured to include a volatile memory such as a random access memory (RAM), and a non-volatile memory such as a read only memory (ROM), an electrically erasable programmable read-only memory (EEPROM), or a programmable ROM (PROM), and stores various types of information such as a control program of the ink jet printer 1.

The print control circuit 21 is configured to include one or a plurality of central processing units (CPU). However, the print control circuit 21 may include a programmable logic device such as a field-programmable gate array (FPGA) instead of a CPU or in addition to the CPU. The print control circuit 21 executes a control program of the ink jet printer 1 stored in the storage circuit 22 and operates according to the control program to control respective portions of the ink jet printer 1. Specifically, the print control circuit 21 generates signals for controlling the operations of respective portions of the ink jet printer 1, such as a designation signal SI, a waveform designation signal dCom, a carriage transport control signal SH1, and a medium transport control signal SH2.

Here, the waveform designation signal dCom is a digital signal for defining a waveform of the drive signal Com. The drive signal Com is an analog signal for driving the ejection portion D. The designation signal SI (an example of a “control signal”) is a digital signal for designating the type of operation of the ejection portion D. Specifically, the designation signal SI designates the type of operation of the ejection portion D, such as the presence or absence of ink ejecting from the ejection portion D, by designating whether the drive signal Com is supplied to the ejection portion D. The carriage transport control signal SH1 and the medium transport control signal SH2 are signals for controlling the transport unit 9.

When print processing is performed, the print control unit 2 generates a signal for controlling the head unit 3, such as the designation signal SI, based on the image data Img. In addition, when the print processing is performed, the print control unit 2 generates a signal for controlling the drive signal generation unit 4, such as the waveform designation signal dCom. In addition, when the print processing is performed, the print control unit 2 generates signals for controlling the transport unit 9, such as the carriage transport control signal SH1 and the medium transport control signal SH2. Thereby, in the print processing, the print control unit 2 causes the transport unit 9 to move the head unit 3 and the recording paper PP, adjusts presence or absence of ink ejecting from the ejection portion D, ink ejection timing, and the like, and controls respective portions of the ink jet printer 1 such that an image corresponding to the image data Img is formed on the recording paper PP.

As illustrated in FIG. 3, the head unit 3 includes a supply circuit 31 and a head portion 32.

The head portion 32 includes M ejection portions D. Here, a value M is a natural number that satisfies “M≥1”. Hereinafter, among the M ejection portions D provided in the head portion 32, the m-th ejection portion D may be referred to as an ejection portion D[m]. Here, a variable m is a natural number that satisfies “1≤m≤M”. In addition, hereinafter, when a constituent element, a signal, or the like of the ink jet printer 1 corresponds to the ejection portion D[m] among the M ejection portions D, a subscript [m] may be added to a reference numeral for representing a corresponding constituent element, a corresponding signal, or the like.

The supply circuit 31 switches whether to supply the drive signal Com to the ejection portion D[m] based on the designation signal SI. Hereinafter, among the drive signals Com, the drive signal Com supplied to the ejection portion D[m] may be referred to as a supply drive signal Vin[m].

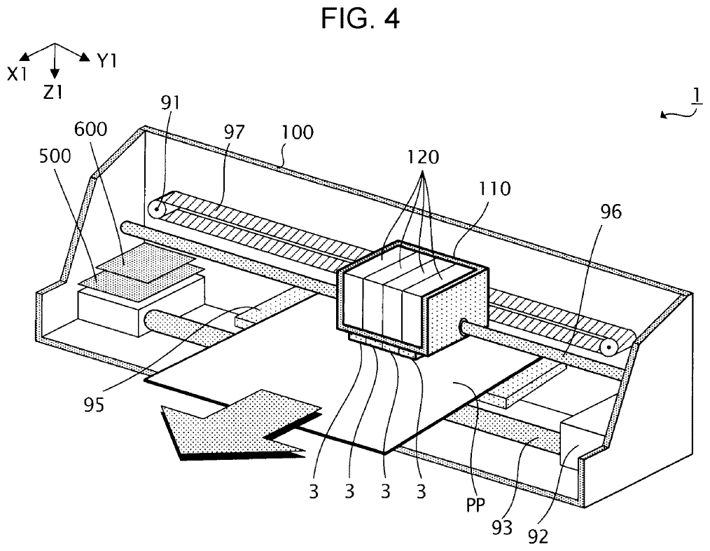

FIG. 4 is a perspective view illustrating an example of a schematic internal structure of the ink jet printer 1.

As illustrated in FIG. 4, in the present embodiment, a case is assumed where the ink jet printer 1 is a serial printer. Specifically, when print processing is performed, the ink jet printer 1 forms an image corresponding to the image data Img on the recording paper PP by transporting the recording paper PP in the X1 direction and ejecting ink from the head unit 3 while the head unit 3 is moved in the Y1 direction or the Y2 direction.

As illustrated in FIG. 4, the ink jet printer 1 according to the present embodiment includes a housing 100 and a carriage 110 that can reciprocate in the housing 100 in the Y-axis direction.

As illustrated in FIG. 4, in the present embodiment, a case is assumed where the carriage 110 is mounted with four ink cartridges 120 corresponding one-to-one to four color inks of cyan, magenta, yellow, and black. In addition, in the present embodiment, as described above, a case is assumed where the carriage 110 is mounted with four head units 3 corresponding one-to-one to the four ink cartridges 120. Each ejection portion D[m] receives the ink supplied from the ink cartridge 120 corresponding to the head unit 3 provided with the ejection portion D[m]. Thereby, each ejection portion D[m] can fill the inside with the supplied ink and eject the ink filled inside the ejection portion D[m] from a nozzle N provided in the ejection portion D[m]. The ink cartridge 120 may be provided outside the carriage 110.

In addition, as described above, the ink jet printer 1 according to the present embodiment includes the transport unit 9. As illustrated in FIG. 4, the transport unit 9 includes a carriage transport motor 91, a medium transport motor 92, a medium transport mechanism 93, a platen 95, a carriage guide shaft 96, and a belt 97. The carriage transport motor 91 drives the belt 97 based on the carriage transport control signal SH1. The belt 97 (an example of a “head transport mechanism”) transports the carriage 110 in the Y-axis direction based on the drive of the carriage transport motor 91. The carriage guide shaft 96 supports the carriage 110 to be reciprocable in the Y-axis direction. The medium transport motor 92 drives the medium transport mechanism 93 based on the medium transport control signal SH2. The medium transport mechanism 93 transports the recording paper PP in the X1 direction by rotating based on the drive of the medium transport motor 92. The platen 95 is provided in the Z1 direction of the carriage 110 and supports the recording paper PP transported by the medium transport mechanism 93. In this way, when print processing is performed, the transport unit 9 causes the head unit 3 and the carriage 110 to reciprocate in the Y-axis direction along the carriage guide shaft 96 by the carriage transport motor 91, and transports the recording paper PP on the platen 95 in the X1 direction by the medium transport motor 92, and accordingly, a relative position of the recording paper PP with respect to the head unit 3 is changed, and the ink can land on the entire recording paper PP. That is, in the present embodiment, the head unit 3 is an example of a “displacement portion”.

As illustrated in FIG. 4, in the present embodiment, a case is assumed where the drive control unit 5 includes a control substrate 500 and the wireless communication unit 6 includes a communication substrate 600.

The control substrate 500 (an example of the “first substrate”) is a circuit substrate fixed to the housing 100. The control substrate 500 is provided with the print control circuit 21 and the storage circuit 22 included in the print control unit 2, and the drive signal generation circuit 40 included in the drive signal generation unit 4. Hereinafter, circuits provided on the control substrate 500, that is, the print control circuit 21, the storage circuit 22, and the drive signal generation circuit 40 may be referred to as a drive control circuit 50 (an example of a “control circuit”).

The communication substrate 600 (an example of the “second substrate”) is a circuit substrate coupled to the control substrate 500. The communication substrate 600 is provided with an antenna 61 and a communication control circuit 62 included in the wireless communication unit 6. The antenna 61 and the communication control circuit 62 will be described below.

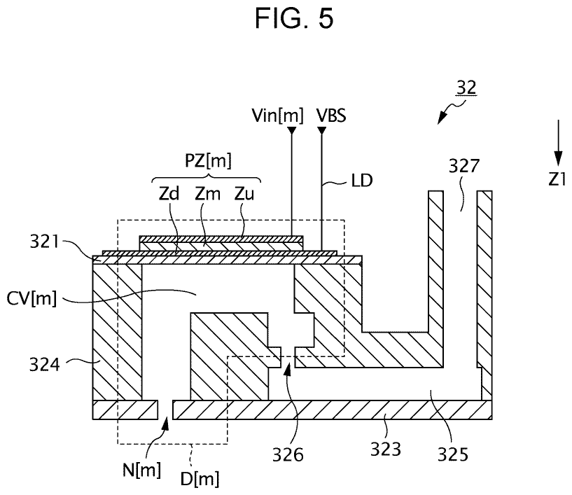

FIG. 5 is a schematic partial cross-sectional view of the head portion 32 in which the head portion 32 is cut to include the ejection portion D[m].

As illustrated in FIG. 5, the ejection portion D[m] includes a piezoelectric element PZ[m], a cavity CV[m] filled with ink, a nozzle N[m] that communicates with the cavity CV[m], and a vibration plate 321. The ejection portion D[m] ejects ink in the cavity CV[m] from the nozzle N[m] by driving the piezoelectric element PZ[m] in response to the supply drive signal Vin[m]. The cavity CV[m] is a space partitioned by a cavity plate 324, a nozzle plate 323 in which the nozzle N[m] is formed, and a vibration plate 321. The cavity CV[m] communicates with a reservoir 325 through an ink supply port 326. The reservoir 325 communicates with the ink cartridge 120 corresponding to the ejection portion D[m] through an ink intake port 327. The piezoelectric element PZ[m] has an upper electrode Zu[m], a lower electrode Zd[m], and a piezoelectric body Zm[m] provided between the upper electrode Zu[m] and the lower electrode Zd[m]. The lower electrode Zd[m] is electrically coupled to a power supply line LD set to a predetermined potential VBS. When a supply drive signal Vin[m] is supplied to the upper electrode Zu[m] and a voltage is applied between the upper electrode Zu[m] and the lower electrode Zd[m], the piezoelectric element PZ[m] is displaced in the Z1 direction and the Z2 direction according to the applied voltage, and as a result, the piezoelectric element PZ[m] vibrates. The lower electrode Zd[m] is bonded to the vibration plate 321. Accordingly, when the piezoelectric element PZ[m] is driven by the supply drive signal Vin[m] and vibrates, the vibration plate 321 also vibrates. The vibration of the vibration plate 321 changes the volume of the cavity CV[m] and the pressure in the cavity CV[m], and accordingly, the ink that fills the cavity CV[m] is ejected from the nozzle N[m].

### A.2. Configuration and Operation of Head Unit 3

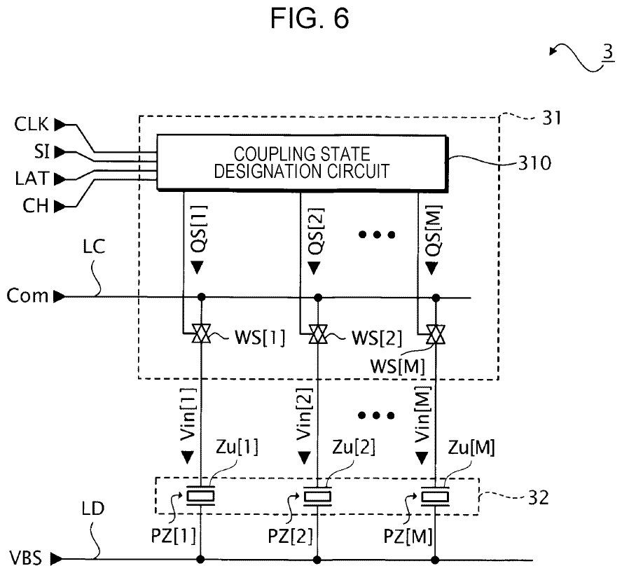

Hereinafter, an example of a configuration and operation of the head unit 3 will be described with reference to FIGS. 6 to 8.

FIG. 6 is a block diagram illustrating an example of a configuration of the head unit 3.

As illustrated in FIG. 6, the head unit 3 includes the supply circuit 31 and the head portion 32. In addition, the head unit 3 includes a wiring line LC to which the drive signal Com is supplied from the drive signal generation unit 4.

As illustrated in FIG. 6, the supply circuit 31 includes M switches WS[1] to WS[M] that correspond one-to-one to the M ejection portions D[1] to D[M], and a coupling state designation circuit 310 that designates a coupling state of each switch.

The coupling state designation circuit 310 generates a coupling state designation signal QS[m] for designating on or off of the switch WS[m], based on at least a part of a designation signal SI, a latch signal LAT, a change signal CH, and a clock signal CLK which are supplied from the print control unit 2. The switch WS[m] switches between conduction and non-conduction of the wiring line LC and the upper electrode Zu[m] of the piezoelectric element PZ[m] provided on the ejection portion D[m], based on the coupling state designation signal QS[m]. In the present embodiment, the switch WS[m] is turned on when the coupling state designation signal QS[m] is at a high level, and is turned off when the coupling state designation signal QS[m] is at a low level. When the switch WS[m] is turned on, the drive signal Com supplied to the wiring line LC is supplied to the upper electrode Zu[m] of the ejection portion D[m] as the supply drive signal Vin[m].

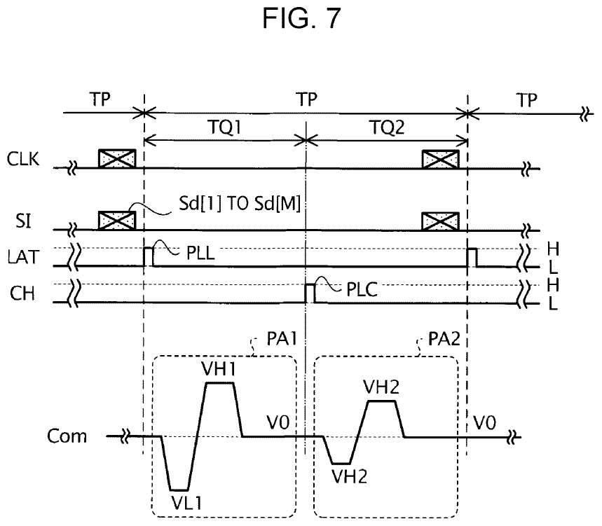

FIG. 7 is a timing chart illustrating an example of various signals, such as the drive signal Com supplied to the head unit 3.

As illustrated in FIG. 7, when the ink jet printer 1 performs print processing, one or a plurality of unit periods TP are set as an operation period of the ink jet printer 1. In the present embodiment, the ink jet printer 1 can drive each ejection portion D[m] for the print processing in each unit period TP.

As illustrated in FIG. 7, the print control unit 2 outputs the latch signal LAT having a pulse PLL. Thereby, the print control unit 2 defines the unit period TP as a period from rising of the pulse PLL to rising of the next pulse PLL. In addition, the print control unit 2 outputs the change signal CH having a pulse PLC in the unit period TP. The print control unit 2 divides the unit period TP into a drive period TQ1 from rising of the pulse PLL to rising of the pulse PLC, and a drive period TQ2 from rising of the pulse PLC to rising of the pulse PLL.

As illustrated in FIG. 7, the designation signal SI includes M individual designation signals Sd[1] to Sd[M] corresponding one-to-one to the M ejection portions D[1] to D[M]. The individual designation signal Sd[m] designates an aspect of driving the ejection portion D[m] in each unit period TP when the ink jet printer 1 performs print processing. The print control unit 2 supplies the designation signal SI including the M individual designation signals Sd[1] to Sd[M] to the coupling state designation circuit 310 in synchronization with the clock signal CLK prior to each unit period TP. The coupling state designation circuit 310 generates the coupling state designation signal QS[m] based on the individual designation signal Sd[m] in the unit period TP.

In the present embodiment, a case is assumed where the ejection portion D[m] can form any one of a large dot formed of ink having an ink amount ξ1, a medium dot formed of ink having an ink amount ξ2 smaller than the ink amount ξ1, and a small dot formed of ink having an ink amount ξ3 smaller than the ink amount ξ2, in the unit period TP in which the print processing is performed.

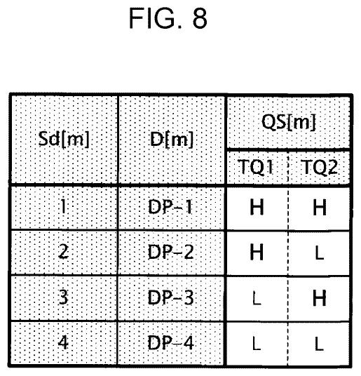

FIG. 8 is an explanatory diagram illustrating an example of the individual designation signal Sd[m].

As illustrated in FIG. 8, in the present embodiment, the individual designation signal Sd[m] can take any one value among four values including a value of “1” that designates the ejection portion D[m] as a large dot forming ejection portion DP-1, a value of “2” that designates the ejection portion D[m] as a medium dot forming ejection portion DP-2, a value of “3” that designates the ejection portion D[m] as a small dot forming ejection portion DP-3, and a value of “4” that designates the ejection portion D[m] as a dot non-forming ejection portion DP-4, in the unit period TP in which the print processing is performed.

Here, the large dot forming ejection portion DP-1 is an ejection portion D that forms a large dot in the unit period TP. In addition, the medium dot forming ejection portion DP-2 is an ejection portion D that forms a medium dot in the unit period TP. In addition, the small dot forming ejection portion DP-3 is an ejection portion D that forms a small dot in the unit period TP. In addition, the dot non-forming ejection portion DP-4 is an ejection portion D that does not form a dot in the unit period TP.

The description returns to FIG. 7.

As illustrated in FIG. 7, in the present embodiment, the drive signal Com has a waveform PA1 provided in the drive period TQ1 and a waveform PA2 provided in the drive period TQ2.

Among the waveforms, the waveform PA1 is a waveform that returns to a potential V0 from the potential V0 via a potential VL1 lower than the potential V0 and a potential VH1 higher than the potential V0. When the supply drive signal Vin[m] having the waveform PA1 is supplied to the ejection portion D[m], the waveform PA1 is determined such that the ink corresponding to an ink amount φ1 is ejected from the ejection portion D[m]. In addition, the waveform PA2 is a waveform that returns to the potential V0 from the potential V0 via a potential VL2 lower than the potential V0 and a potential VH2 higher than the potential V0. When the supply drive signal Vin[m] having the waveform PA2 is supplied to the ejection portion D[m], the waveform PA2 is determined such that the ink corresponding to an ink amount φ2 is ejected from the ejection portion D[m]. In the present embodiment, a case is assumed where the ink amount ξ1 corresponds to the total amount of the ink amount φ1 and the ink amount φ2, the ink amount ξ2 corresponds to the ink amount φ1, and the ink amount ξ3 corresponds to the ink amount φ2.

In addition, in the present embodiment, as an example, a case is assumed where, when a potential of the supply drive signal Vin[m] supplied to the ejection portion D[m] is high, a volume of the cavity CV[m] provided in the ejection portion D[m] is smaller as compared with a case of a low potential. Accordingly, when the ejection portion D[m] is driven by the supply drive signal Vin[m] having the waveform PA1 or the like, a potential of the supply drive signal Vin[m] changes from a low potential to a high potential, and thereby, the ink in the ejection portion D[m] is ejected from the nozzle N[m].

As illustrated in FIG. 8, when the individual designation signal Sd[m] indicates the value “1” that designates the ejection portion D[m] as the large dot forming ejection portion DP-1 in the unit period TP, the coupling state designation circuit 310 sets the coupling state designation signal QS[m] to a high level in the drive period TQ1 and the drive period TQ2. In this case, the switch WS[m] is turned on in the drive period TQ1 and the drive period TQ2. Accordingly, the ejection portion D[m] is driven by the supply drive signal Vin[m] having the waveform PA1 and the waveform PA2 in the unit period TP, and ejects the ink having the ink amount ξ1 corresponding to a large dot.

In addition, when the individual designation signal Sd[m] indicates the value “2” that designates the ejection portion D[m] as the medium dot forming ejection portion DP-2 in the unit period TP, the coupling state designation circuit 310 sets the coupling state designation signal QS[m] to a high level in the drive period TQ1. In this case, the switch WS[m] is turned on in the drive period TQ1. Accordingly, the ejection portion D[m] is driven by the supply drive signal Vin[m] having the waveform PA1 in the unit period TP, and ejects the ink having the ink amount ξ2 corresponding to a medium dot.

In addition, when the individual designation signal Sd[m] indicates the value “3” that designates the ejection portion D[m] as the small dot forming ejection portion DP-3 in the unit period TP, the coupling state designation circuit 310 sets the coupling state designation signal QS[m] to a high level in the drive period TQ2. In this case, the switch WS[m] is turned on in the drive period TQ2. Accordingly, the ejection portion D[m] is driven by the supply drive signal Vin[m] having the waveform PA2 in the unit period TP, and ejects the ink having the ink amount ξ3 corresponding to a small dot.

In addition, when the individual designation signal Sd[m] indicates the value “4” that designates the ejection portion D[m] as the dot non-forming ejection portion DP-4 in the unit period TP, the coupling state designation circuit 310 sets the coupling state designation signal QS[m] to a low level over the unit period TP. In this case, the switch WS[m] is turned off over the unit period TP. Accordingly, the ejection portion D[m] is not driven by the supply drive signal Vin[m] and does not eject the ink in the unit period TP.

### A.3. Configuration of Drive Signal Generation Circuit 40

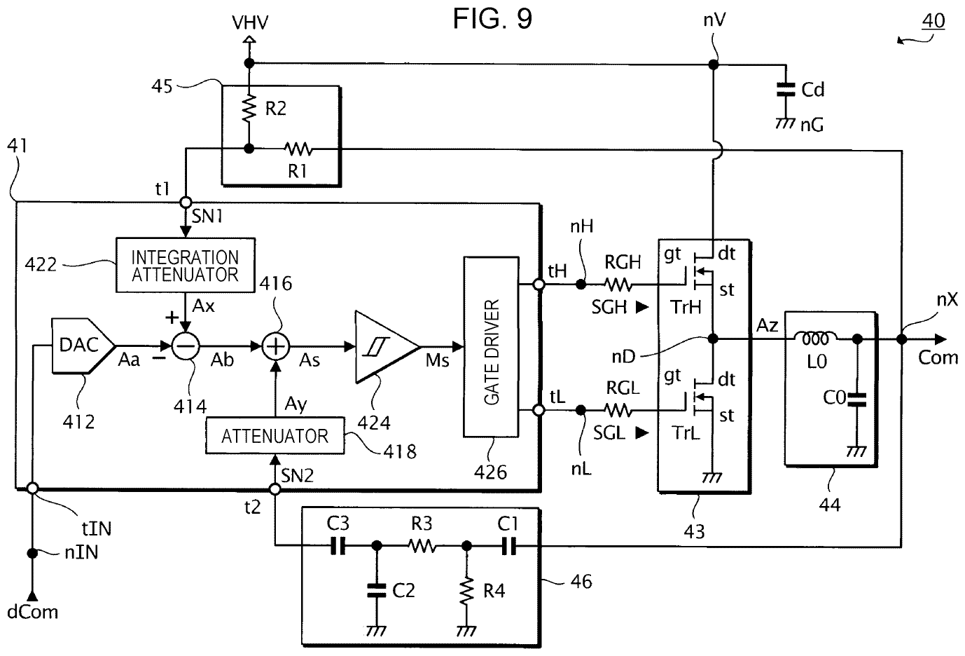

Hereinafter, an example of a configuration of the drive signal generation circuit 40 provided in the drive signal generation unit 4 will be described with reference to FIG. 9.

FIG. 9 is a block diagram illustrating an example of a circuit configuration of the drive signal generation circuit 40.

As illustrated in FIG. 9, the drive signal generation circuit 40 includes an integrated circuit 41, an amplification circuit 43, a smoothing circuit 44, a pull-up circuit 45, a filter circuit 46, and an electrolytic capacitor Cd, and is a D-class amplification circuit that generates the drive signal Com based on the waveform designation signal dCom.

The integrated circuit 41 is, for example, a large scale integration (LSI), and generates a gate signal SGH and a gate signal SGL based on the waveform designation signal dCom supplied to a terminal tIN through a node nIN. The integrated circuit 41 includes an analog conversion circuit 412, a subtractor 414, an adder 416, an attenuator 418, an integration attenuator 422, a comparator 424, and a gate driver 426.

The analog conversion circuit 412 is a digital to analog converter (DAC) and converts a digital waveform

designation signal dCom into an analog signal Aa. A voltage amplitude of the signal Aa is, for example, about 0 to 2 volts, and a voltage amplified to about 20 times is the drive signal Com. That is, the signal Aa is a signal before amplification of the drive signal Com.

The integration attenuator 422 outputs a signal Ax obtained by attenuating and then integrating a signal SN1 input to a terminal t1 to be described below.

The subtractor 414 outputs a signal Ab indicating a potential obtained by subtracting a potential of the signal Aa from a potential of the signal Ax.

The attenuator 418 outputs a signal Ay obtained by attenuating a high frequency component of a signal SN2 input to a terminal t2 to be described below.

The adder 416 outputs a signal As indicating a potential obtained by adding a potential of the signal Ab to a potential of the signal Ay.

The comparator 424 outputs the modulation signal Ms obtained by pulse-modulating the signal As. Specifically, the comparator 424 outputs the modulation signal Ms that goes to a high level when a voltage of the modulation signal Ms is equal to or greater than a threshold voltage Vth1 while a voltage of the signal As rises, and goes to a low level when the voltage of the modulation signal Ms falls below a threshold voltage Vth2 while the voltage of the signal As falls. The threshold voltage Vth1 and the threshold voltage Vth2 are set to have a relationship of “Vth1>Vth2”.

A power supply voltage of a circuit from the analog conversion circuit 412 to the comparator 424 is, for example, a low voltage, such as 3.3 volts. In contrast to this, the drive signal Com has a large amplitude and may exceed, for example, 40 volts. Accordingly, in the integration attenuator 422, the signal SN1 having an amplitude corresponding to the drive signal Com is attenuated, and an amplitude range of the signal Ax is matched with an amplitude range of a signal in the circuit from the analog conversion circuit 412 to the comparator 424.

In addition, in the present embodiment, a digital signal is exemplified and described as the waveform designation signal dCom, but the waveform designation signal dCom may be any signal that defines a target value for generating the drive signal Com, and for example, the analog signal Aa may be used as the waveform designation signal dCom. When the signal Aa is the waveform designation signal dCom, the integrated circuit 41 may be configured without including the analog conversion circuit 412.

The gate driver 426 outputs the gate signal SGH, which is obtained by converting the modulation signal Ms into a signal having a specific amplitude, to a node nH through a terminal tH. In addition, the gate driver 426 outputs the gate signal SGL, which is obtained by converting a signal obtained by inverting a logic level of the modulation signal Ms into a logic level of a signal having a specific amplitude, to a node nL through a terminal tL.

The amplification circuit 43 includes, for example, a transistor TrH and a transistor TrL, and generates an amplification signal Az that is a signal obtained by amplifying the modulation signal Ms, based on the gate signal SGH and the gate signal SGL output from the integrated circuit 41. In the present embodiment, as an example, a case is assumed where the transistor TrH and the transistor TrL are field effect transistors. More specifically, in the present embodiment, a case is assumed where N-channel type metal-oxide-semiconductor field-effect transistors (MOSFETs) are adopted as the transistor TrH and the transistor TrL.

The gate signal SGH output from the gate driver 426 to the terminal tH is input to a gate electrode gt of the transistor TrH through the node nH and a resistor RGH. In addition, the gate signal SGL output from the gate driver 426 to the terminal tL is input to a gate electrode gt of the transistor TrL through the node nL and a resistor RGL. Logic levels of the gate signal SGH and the gate signal SGL are in a mutually exclusive relationship. Here, the “mutually exclusive relationship” means that a signal level of the gate signal SGH supplied to the gate electrode gt of the transistor TrH and a signal level of the gate signal SGL supplied to the gate electrode gt of the transistor TrL are not at high level at the same time, in other words, the transistor TrH and the transistor TrL do not turn on at the same time. The transistor TrH turns on when a potential of the gate electrode gt of the transistor TrH is at a high level, and turns off when the potential of the gate electrode gt of the transistor TrH is at a low level. The transistor TrL turns on when a potential of the gate electrode gt of the transistor TrL is at a high level, and turns off when the potential of the gate electrode gt of the transistor TrL is at a low level.

A drain electrode dt of the transistor TrH is electrically coupled to a node nV set to a power supply potential VHV on a high potential side, and a source electrode st thereof is electrically coupled to a node nD. In addition, a source electrode st of the transistor TrL is electrically coupled to a node nG set to a ground potential, and a drain electrode dt thereof is electrically coupled to the node nD. The source electrode of the transistor TrL may be electrically coupled to a power supply line LD set to a potential VBS.

As described above, the transistor TrH turns on when the gate signal SGH supplied to the gate electrode gt is at a high level, and turns off when the gate signal SGH is at a low level. The transistor TrL turns on when the gate signal SGL supplied to the gate electrode gt is at a high level, and turns off when the gate signal SGL is at a low level. Accordingly, the amplification signal Az obtained by amplifying the modulation signal Ms is output to the node nD in which the source electrode st of the transistor TrH is electrically coupled to the drain electrode dt of the transistor TrL.

The electrolytic capacitor Cd is coupled to the node nV to which a power supply potential VHV is supplied. One end of the electrolytic capacitor Cd is electrically coupled to the node nV, and the other end thereof is electrically coupled to the node nG set to a ground potential. In the present embodiment, the electrolytic capacitor Cd is, for example, a large-capacity aluminum electrolytic capacitor and suppresses a potential fluctuation at the node nV to stabilize the power supply potential VHV.

The smoothing circuit 44 is a low pass filter (LPF), and generates the drive signal Com by smoothing the amplification signal Az. The smoothing circuit 44 includes an inductor L0 and a capacitor C0. One end of the inductor L0 is electrically coupled to the node nD, and the other end thereof is electrically coupled to a node nX. One end of the capacitor C0 is electrically coupled to the node nX, and the other end thereof is electrically coupled to the node nG set to a ground potential.

The pull-up circuit 45 feeds back the signal SN1, which is obtained by pulling up the drive signal Com output to the node nX, to the terminal t1. The pull-up circuit 45 includes a resistor R1 having one end electrically coupled to the node nX and the other end electrically coupled to the terminal t1, and a resistor R2 having one end electrically coupled to the terminal t1 and the other end electrically coupled to the node nV set to the power supply potential VHV.

The filter circuit 46 is a band pass filter (BPF), and feeds back a signal SN2, which is obtained by removing a direct current (DC) component from a frequency component in a predetermined bandwidth of the drive signal Com, to the terminal t2. The filter circuit 46 includes a resistor R3, a capacitor C1 having one end electrically coupled to the node nX and the other end electrically coupled to one end of the resistor R3, a resistor R4 having one end electrically coupled to one end of the resistor R3 and the other end electrically coupled to the node nG set to a ground potential, a capacitor C2 having one end electrically coupled to the other end of the resistor R3 and the other end electrically coupled to the node nG set to the ground potential, and a capacitor C3 having one end electrically coupled to the other end of the resistor R3 and the other end electrically coupled to the terminal t2. Among these, the capacitor C1 and the resistor R4 function as a high pass filter (HPF) that allows a high frequency component of the drive signal Com equal to or higher than a cutoff frequency to pass therethrough. In addition, the resistor R3 and the capacitor C2 function as a low pass filter (LPF) that allows a low frequency component of the drive signal Com equal to or less than a cutoff frequency to pass therethrough. In the present embodiment, in the filter circuit 46, the cutoff frequency of the HPF is set to be lower than the cutoff frequency of the LPF. Accordingly, the filter circuit 46 causes frequency components in a predetermined bandwidth of the drive signal Com, which are equal to or higher than the cutoff frequency of the HPF and are equal to or lower than the cutoff frequency of the LPF, to pass therethrough. In addition, since the filter circuit 46 includes the capacitor C3, the filter circuit 46 feeds back a signal, which is obtained by removing a DC component from the drive signal Com having a frequency component in a predetermined bandwidth that passes through the HPF and the LPF, to the terminal t2.

In this way, the drive signal generation circuit 40 generates the drive signal Com by smoothing the amplification signal Az in the node nD by using the smoothing circuit 44. The drive signal Com is integrated and subtracted by the integration attenuator 422 and then is fed back to the subtractor 414. Therefore, self-oscillation occurs at a frequency determined by a delay in the smoothing circuit 44, a delay in the integration attenuator 422, and a feedback transfer function. Meanwhile, since a delay amount of a feedback path through the terminal t1 is large, a frequency of the self-oscillation cannot be increased to such an extent that the accuracy of a waveform of the drive signal Com can be sufficiently ensured only by the feedback through the terminal t1. In contrast to this, in the present embodiment, since a path for feeding back a high frequency component of the drive signal Com is provided through the terminal t2 in addition to the path through the terminal t1, the delay of the feedback in the entire drive signal generation circuit 40 can be reduced. That is, in the present embodiment, since a frequency of the signal As, which is obtained by adding the signal Ay that is a high frequency component of the drive signal Com to the signal Ab, can be increased as compared with a case where a path through the terminal t2 does not exist, accuracy of the drive signal Com can be sufficiently ensured.

In the present embodiment, the electrolytic capacitor Cd included in the drive signal generation circuit 40 of the drive control circuit 50 is an example of an “electronic component”.

### A.4. Configurations of Drive Control Unit 5 and Wireless Communication Unit 6

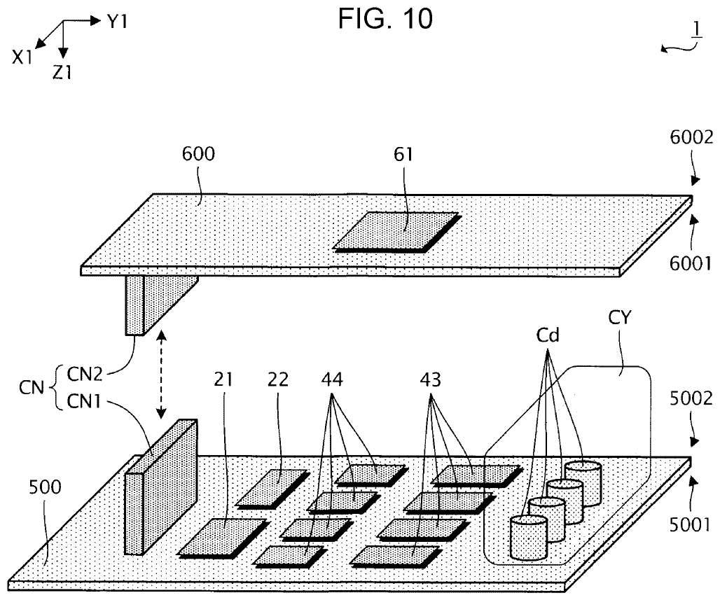

Hereinafter, configurations of a drive control unit 5 and a wireless communication unit 6 will be described with reference to FIGS. 10 to 12.

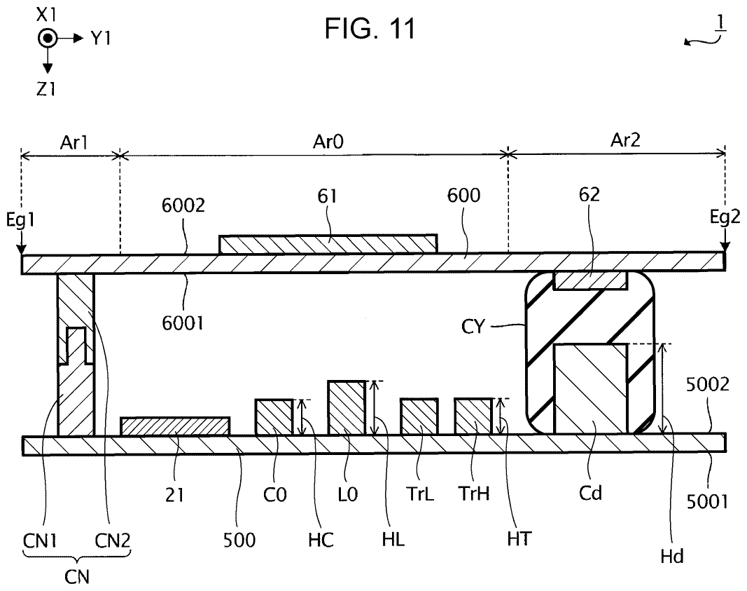

FIG. 10 is an exploded perspective view illustrating an example of a configuration including the drive control unit 5 and the wireless communication unit 6. FIG. 11 is a cross-sectional view illustrating an example of the configuration including the drive control unit 5 and the wireless communication unit 6.

As illustrated in FIGS. 10 and 11, an ink jet printer 1 includes the drive control unit 5, the wireless communication unit 6, a substrate-to-substrate connector CN, and a support column CY.

As described above, the wireless communication unit 6 includes a communication substrate 600, and an antenna 61 and a communication control circuit 62 provided on the communication substrate 600.

The communication substrate 600 has a lower surface 6001 (an example of a “first surface”) facing the Z1 direction and an upper surface 6002 (an example of a “second surface”) facing the Z2 direction, which is a surface opposite to the lower surface 6001.

The antenna 61 is an element for transmitting and receiving a signal by wireless communication, and is provided on the upper surface 6002.

The communication control circuit 62 (an example of a “communication circuit”) is a circuit for controlling the performance of wireless communication using the antenna 61, and is provided on the lower surface 6001.

As described above, the drive control unit 5 includes a control substrate 500 and a drive control circuit 50 provided on the control substrate 500.

The control substrate 500 has a lower surface 5001 facing the Z1 direction and an upper surface 5002 facing the Z2 direction, which is a surface opposite to the lower surface 5001. In the present embodiment, the upper surface 5002 of the control substrate 500 faces the lower surface 6001 of the communication substrate 600.

As described above, the drive control circuit 50 includes the print control circuit 21, the storage circuit 22, and the drive signal generation circuit 40. The drive signal generation circuit 40 includes the amplification circuit 43 including the transistor TrH and the transistor TrL, the smoothing circuit 44 including the inductor L0 and the capacitor C0, and the electrolytic capacitor Cd. In the present embodiment, the drive control circuit 50 is provided on the upper surface 5002.

In the present embodiment, a case is assumed where a height Hd of the electrolytic capacitor Cd in the Z-axis direction is higher than heights HT of the transistor TrH and the transistor TrL in the Z-axis direction, a height HL of the inductor L0 in the Z-axis direction, and a height HC of the capacitor C0 in the Z-axis direction. In the present embodiment, a case is assumed where the electrolytic capacitor Cd has a larger volume than other electronic components that configure the drive control circuit 50.

The substrate-to-substrate connector CN (an example of a “coupling component”) couples the control substrate 500 to the communication substrate 600. Specifically, the substrate-to-substrate connector CN includes a connector component CN1 fixed to the upper surface 5002 of the control substrate 500, and a connector component CN2 fixed to the lower surface 6001 of the communication substrate 600 and capable of being fitted to the connector component CN1. The connector component CN1 is, for example, a male connector, and the connector component CN2 is, for example, a female connector. The substrate-to-substrate connector CN couples the control substrate 500 to the communication substrate 600 by fitting the connector component CN1 to the connector component CN2, and enables transmission of signals between the control substrate 500 and the communication substrate 600.

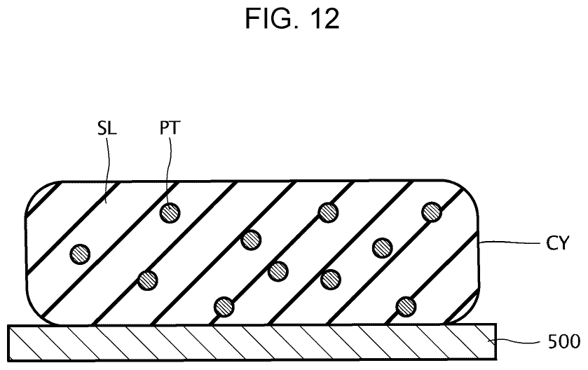

FIG. 12 is a schematic view illustrating an example of the support column Cy.

As illustrated in FIG. 12, the support column CY includes a base material SL and heat conductive particles PT.

The base material SL is a clay-like material with an electrical insulation property. For example, clay configured with silicone can be adopted as the base material SL.

The heat conductive particles PT are particles, each being made of a material with a high thermal conductivity, such as diamond, gold, silver, and copper, and are dispersed in the base material SL. In the present embodiment, the heat conductive particles PT are provided such that diameters of the heat conductive particles PT are sufficiently smaller than an interval between wiring lines included in the drive control circuit 50. Accordingly, in the present embodiment, even when a conductive material is adopted as the heat conductive particles PT, the support column CY can suppress electrical coupling between two components of the drive control circuit 50, and the entire support column CY can maintain an electrical insulation property.

As illustrated in FIGS. 10 and 11, the support column CY is provided between the upper surface 5002 of the control substrate 500 and the lower surface 6001 of the communication substrate 600 to support the communication substrate 600 with respect to the control substrate 500.

Specifically, in the present embodiment, the support column CY is provided to cover a part or entirety of the electrolytic capacitor Cd and a part or entirety of the communication control circuit 62 when the drive control unit 5 and the wireless communication unit 6 are viewed in a plan view in the Z1 direction. That is, in the present embodiment, the support column CY is provided to overlap a part or entirety of the electrolytic capacitor Cd and a part or entirety of the communication control circuit 62 when the drive control unit 5 and the wireless communication unit 6 are viewed in a plan view in the Z1 direction.

Meanwhile, the present disclosure is not limited to such an aspect. When the drive control unit 5 and the wireless communication unit 6 are viewed in a plan view in the Z1 direction, the support column CY may be provided not to overlap the communication control circuit 62. In addition, when the drive control unit 5 and the wireless communication unit 6 are viewed in a plan view in the Z1 direction, the support column CY may be provided not to overlap the electrolytic capacitor Cd.

In addition, in the present embodiment, the communication substrate 600 includes an end region Ar1, an end region Ar2, and an intermediate region Ar0. Here, the end region Ar1 (an example of the “first region”) includes an end portion Eg1 of the communication substrate 600 in the Y2 direction when the communication substrate 600 is viewed in a plan view in the Z1 direction, and is a region near the end portion Eg1. The end region Ar2 (an example of the “second region”) includes an end portion Eg2 of the communication substrate 600 in the Y1 direction when the communication substrate 600 is viewed in a plan view in the Z1 direction, and is a region near the end portion Eg2. The intermediate region Ar0 is a region between the end region Ar1 and the end region Ar2 when the communication substrate 600 is viewed in a plan view in the Z1 direction.

In the present embodiment, the connector component CN2 is fixed to the lower surface 6001 in the end region Ar1 of the communication substrate 600, and the support column CY is provided to support the lower surface 6001 in the end region Ar2 of the communication substrate 600.

### A.5. Comparative Example

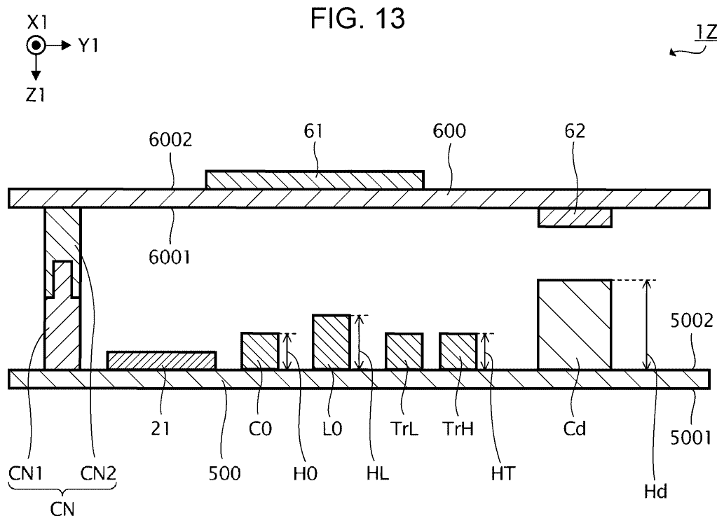

Hereinafter, in order to clarify effects of the present embodiment, an ink jet printer 1Z according to a comparative example will be described with reference to FIG. 13.

FIG. 13 is a cross-sectional view illustrating an example of a configuration of the ink jet printer 1Z according to the comparative example.

As illustrated in FIG. 13, the ink jet printer 1Z according to the comparative example is configured in the same manner as the ink jet printer 1 according to an embodiment, except that the support column CY is not provided.

In the comparative example, vibration occurs in the ink jet printer 1Z due to transport of the recording paper PP by the transport unit 9, transport of the carriage 110 by the transport unit 9, carrying of the ink jet printer 1Z by a user of the ink jet printer 1Z, and the like. When the vibration occurs in the ink jet printer 1Z, a slight change may occur in a relative position between the control substrate 500 and the communication substrate 600, and in addition, a slight change may occur in a relative posture between the control substrate 500 and the communication substrate 600. When a change occurs in the relative position or the relative posture between the control substrate 500 and the communication substrate 600, a load is applied between the substrate-to-substrate connector CN and the control substrate 500, and between the substrate-to-substrate connector CN and the communication substrate 600, and so-called fretting may occur in which at least a part of surfaces of the substrate-to-substrate connector CN, the control substrate 500, and the communication substrate 600 is damaged. When surface damage occurs in at least a part of the substrate-to-substrate connector CN, the control substrate 500, and the communication substrate 600, fine fragments may be scraped off from the components. Then, the fragment generated due to a surface damage is oxidized, and as the oxidized fragment comes into contact with a bonded portion of the substrate-to-substrate connector CN and a substrate (the control substrate 500 and the communication substrate 600), a contact failure is induced between the substrate-to-substrate connector CN and the substrate, or as the oxidized fragment comes into contact with a circuit, such as the drive control circuit 50, a contact failure is induced in the circuit, that is, so-called fretting corrosion may occur.

In contrast to this, in the present embodiment, the communication substrate 600 is supported by the support column CY with respect to the control substrate 500, in addition to being coupled to the control substrate 500 by the substrate-to-substrate connector CN. Accordingly, according to the present embodiment, as compared with the comparative example, when vibration occurs in the ink jet printer 1, it is possible to reduce the degree of change in relative position and posture between the control substrate 500 and the communication substrate 600. Accordingly, according to the present embodiment, as compared with the comparative example, it is possible to reduce the possibility that damage occurs on at least a part of surfaces of the substrate-to-substrate connector CN, the control substrate 500, and the communication substrate 600, and to reduce the possibility of occurrence of fragments due to a surface damage in these components. Therefore, according to the present embodiment, as compared with the comparative example, it is possible to suppress a contact failure between the substrate-to-substrate connector CN and substrates (the control substrate 500 and the communication substrate 600) due to the fragments generated by a surface damage, and to suppress a contact failure inside the circuits of the drive control circuit 50 and the like due to the fragments generated by the surface damage. That is, according to the present embodiment, the degree of damage can be reduced due to fretting as compared with the comparative example, and thus, the possibility of occurrence of a defect due to fretting corrosion can be reduced.

### A.6. Summary of First Embodiment

As described above, according to the present embodiment, the communication substrate 600 is supported by the support column CY with respect to the control substrate 500 in addition to being coupled to the control substrate 500 by the substrate-to-substrate connector CN, and thus, as compared with an aspect in which the support column CY is not provided, it is possible to reduce the degree of change in relative position and posture between the control substrate 500 and the communication substrate 600, and it is possible to reduce the possibility of occurrence of fragments due to a surface damage in at least a part of the substrate-to-substrate connector CN, the control substrate 500, and the communication substrate 600. Therefore, according to the present embodiment, the possibility of occurrence of a defect due to fretting corrosion can be reduced as compared with an aspect in which the support column CY is not provided.

In addition, according to the present embodiment, as compared with an aspect in which the support column CY is provided to cover the electrolytic capacitor Cd and the support column CY is disposed directly on the upper surface 5002 of the control substrate 500 without covering the electrolytic capacitors Cd, a height of the support column CY, which is clay-like and has low rigidity, in the Z-axis direction can be reduced, and the communication substrate 600 can be more stably supported on the control substrate 500.

In addition, according to the present embodiment, as compared with an aspect in which the support column CY is provided to cover the communication control circuit 62 and directly supports the lower surface 6001 of the communication substrate 600 without covering the communication control circuit 62, and thus, a height of the support column CY in the Z-axis direction can be reduced, and the communication substrate 600 can be more stably supported by the control substrate 500.

In addition, according to the present embodiment, the antenna 61 is provided on the upper surface 6002. Accordingly, according to the present embodiment, as compared with an aspect in which the antenna 61 is provided on the lower surface 6001, it is possible to reduce the possibility that transmission and reception of the signal of the antenna 61 is disrupted by the communication substrate 600 or the support column CY.

In addition, according to the present embodiment, the communication substrate 600 is provided separately from the control substrate 500. Accordingly, according to the present embodiment, as compared with an aspect in which the communication substrate 600 and the control substrate 500 are provided as a single substrate, the communication substrate 600 can be easily removed from the ink jet printer 1. Therefore, according to the present embodiment, for example, when the ink jet printer 1 is discarded, it is possible to reduce costs related to the reuse of the communication substrate 600 and to reduce an environmental load of the ink jet printer 1. In addition, according to the present embodiment, for example, when a communication method used by the ink jet printer 1 changes, it is possible to easily replace the communication substrate 600 with another communication substrate 600 corresponding to a scheduled communication method used by the ink jet printer 1, and to use the ink jet printer 1 in a more diverse environment.

It is preferable that a color of the support column CY is different from at least one of a color of the control substrate 500 and a color of the communication substrate 600. In the present embodiment, a case is assumed where the support column CY has a color different from a color of the control substrate 500 and has a color different from a color of the communication substrate 600.

In addition, according to the present embodiment, since the support column CY is in contact with the control substrate 500 and the communication substrate 600, it is possible to dissipate the heat generated in the drive control circuit 50 through the support column CY and the communication substrate 600.

In addition, according to the present embodiment, the substrate-to-substrate connector CN is fixed to the communication substrate 600 in the end region Ar1, and the support column CY supports the communication substrate 600 in the end region Ar2, and thus, the communication substrate 600 can be more stably supported on the control substrate 500, as compared with an aspect in which one or both of the substrate-to-substrate connector CN and the support column CY are provided in the intermediate region Ar0.

### B. Second Embodiment

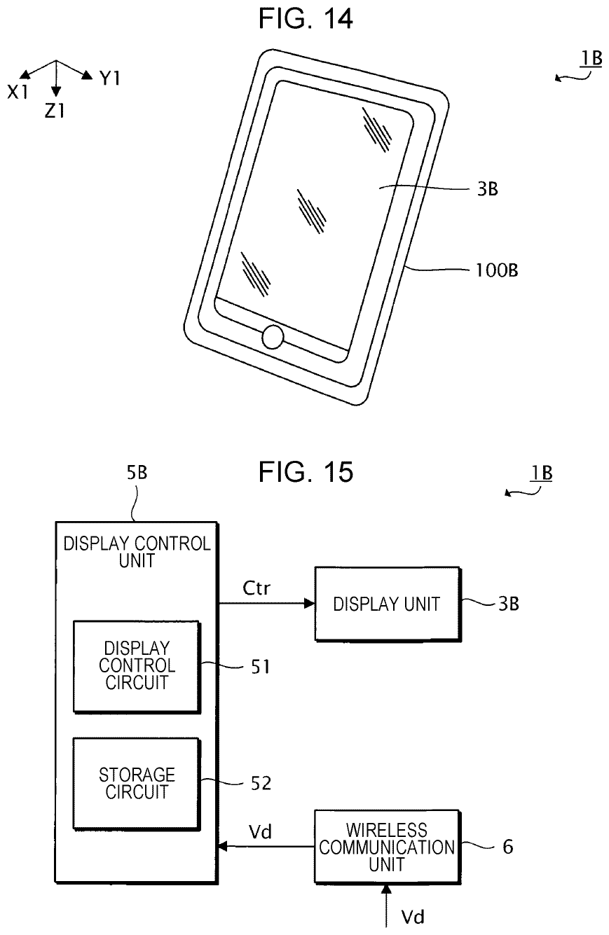

In the second embodiment, an electronic device will be described with reference to FIGS. 14 to 16 by using a smartphone 1B as an example. In each embodiment to be illustrated below, elements having the same operation and function as the first embodiment will be denoted by the same reference numerals used in the descriptions of the first embodiment, and detailed descriptions thereof are omitted as appropriate.

FIG. 14 is an external perspective view illustrating an example of an appearance of the smartphone 1B.

As illustrated in FIG. 14, the smartphone 1B is an electronic device that can be carried by a user of the smartphone 1B, and includes a housing 100B and a display unit 3B.

FIG. 15 is a functional block diagram illustrating an example of a configuration of the smartphone 1B.

As illustrated in FIG. 15, the smartphone 1B is supplied with video data Vd indicating a video to be displayed by the smartphone 1B from a host computer, such as a personal computer or a digital camera. The smartphone 1B causes the display unit 3B to display a video indicated by the video data Vd supplied from the host computer.

As illustrated in FIG. 15, the smartphone 1B includes a wireless communication unit 6 that acquires the video data Vd by wireless communication, a display control unit 5B that generates a display control signal Ctr based on the video data Vd, and the display unit 3B that displays a video indicated by the video data Vd based on the display control signal Ctr.

In the present embodiment, the smartphone 1B is an example of an “electronic device”, the display unit 3B is an example of a “drive device”, the display control signal Ctr is an example of a “control signal”, and the video data Vd is an example of “instruction information”.

The display control unit 5B includes a display control circuit 51 that generates the display control signal Ctr based on the video data Vd supplied from the wireless communication unit 6, and a storage circuit 52 that stores various types of information, such as a control program of the smartphone 1B. Hereinafter, a circuit including the display control circuit 51 and the storage circuit 52 will be referred to as a drive control circuit 50B.

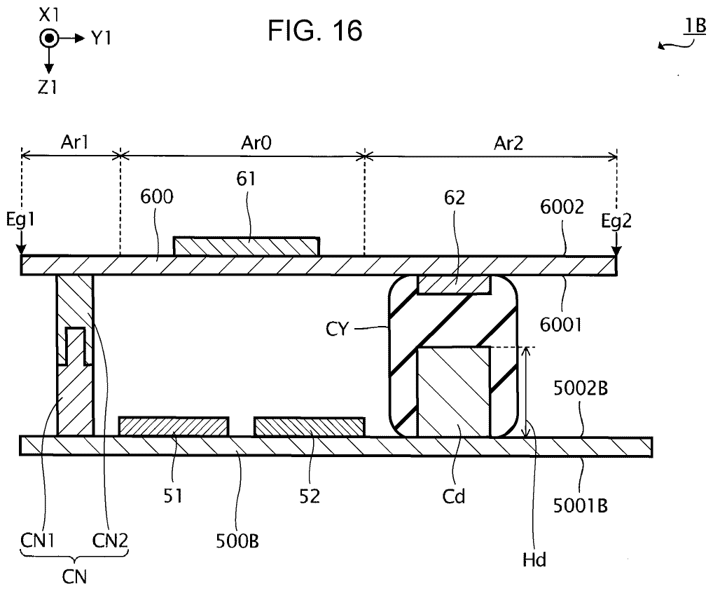

FIG. 16 is a cross-sectional view illustrating an example of a configuration of the smartphone 1B including the display control unit 5B and the wireless communication unit 6.

As illustrated in FIG. 16, the smartphone 1B includes the display control unit 5B, the wireless communication unit 6, a substrate-to-substrate connector CN, and a support column CY.

The wireless communication unit 6 includes a communication substrate 600, and an antenna 61 and a communication control circuit 62 which are provided on the communication substrate 600, as in the first embodiment.

The display control unit 5B includes a control substrate 500B and a drive control circuit 50B provided on the control substrate 500B.

The control substrate 500B (another example of the “first substrate”) includes a lower surface 5001B facing a Z1 direction and an upper surface 5002B facing a Z2 direction, which is a surface opposite to the lower surface 5001B. In the present embodiment, the upper surface 5002B of the control substrate 500B faces a lower surface 6001 of the communication substrate 600.

The drive control circuit 50B includes an electrolytic capacitor Cd in addition to the display control circuit 51 and the storage circuit 52 described above. In the present embodiment, the drive control circuit 50B is provided on the upper surface 5002B.

In the present embodiment, a case is assumed where a height Hd of the electrolytic capacitor Cd in a Z-axis direction is higher than heights of the display control circuit 51 and the storage circuit 52 in the Z-axis direction. In the present embodiment, a case is assumed where the electrolytic capacitor Cd has a larger volume than other electronic components that configure the drive control circuit 50B. In the present embodiment, the electrolytic capacitor Cd is an example of the “first electronic component”, and the communication control circuit 62 is an example of the “second electronic component”.

In the present embodiment, the substrate-to-substrate connector CN couples the control substrate 500B to the communication substrate 600. Specifically, in the present embodiment, a connector component CN1 included in the substrate-to-substrate connector CN is fixed to the upper surface 5002B of the control substrate 500B, and a connector component CN2 included in the substrate-to-substrate connector CN is fixed to the lower surface 6001 of the communication substrate 600. The substrate-to-substrate connector CN couples the control substrate 500B to the communication substrate 600 by fitting the connector component CN1 to the connector component CN2, and enables transmission of signals between the control substrate 500B and the communication substrate 600.

As described above, according to the present embodiment, the communication substrate 600 is supported by the support column CY with respect to the control substrate 500B in addition to being coupled to the control substrate 500B by the substrate-to-substrate connector CN, and thus, as compared with an aspect in which the support column CY is not provided, it is possible to reduce the degree of change in relative position and posture between the control substrate 500B and the communication substrate 600 and to reduce the possibility of occurrence of fragments due to a surface damage in at least a part of the substrate-to-substrate connector CN, the control substrate 500B, and the communication substrate 600. Therefore, according to the present embodiment, the possibility of occurrence of a defect due to fretting corrosion can be reduced as compared with an aspect in which the support column CY is not provided.

In the present embodiment, the communication substrate 600 may be a substrate having one side of 1 inch or less. Specifically, for example, the communication substrate 600 may be a Wi-Fi (registered trademark) chip having one side of 1 inch or less.

In addition, also in the present embodiment, as in the first embodiment, the connector component CN2 is fixed to the lower surface 6001 in an end region Ar1 of the communication substrate 600, and the support column CY is provided to support the lower surface 6001 in an end region Ar2 of the communication substrate 600.

### C. Modification Example

Each embodiment described above can be variously modified. Specific modification aspects will be described below. Two or more aspects selected in any manner from following examples can be combined with each other as appropriate within a range not inconsistent with each other. In the modification examples to be described below, elements having the same operations and functions as the embodiments will be denoted by the reference numerals used in the descriptions above, and detailed descriptions thereof are omitted as appropriate.

### Modification Example 1

In the first embodiment and the second embodiment described above, an aspect in which the support column CY is provided to cover only the electrolytic capacitor Cd of the drive control circuit 50 or the drive control circuit 50B is described as an example, but the present disclosure is not limited to such an aspect. The support column CY may be provided to cover electronic components other than the electrolytic capacitor Cd in the drive control circuit 50 or the drive control circuit 50B. In this case, the support column CY may be provided to cover the electrolytic capacitor Cd, or may be provided not to cover the electrolytic capacitor Cd.

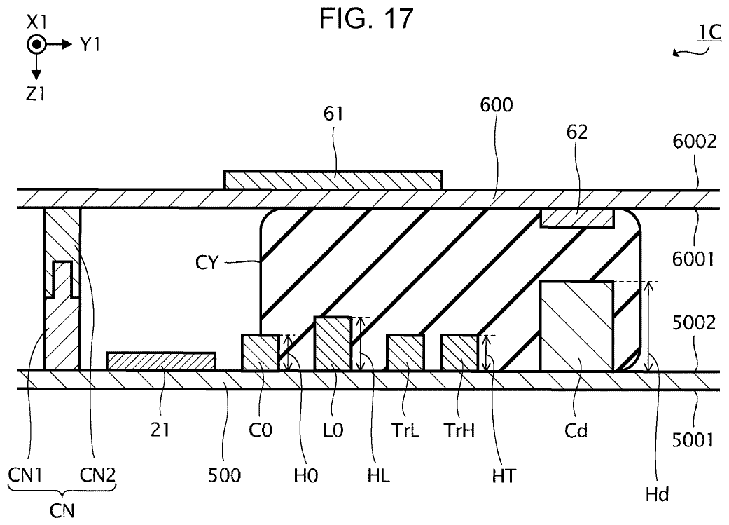

FIG. 17 is a cross-sectional view illustrating an example of a configuration of an ink jet printer 1C according to modification example 1.

As illustrated in FIG. 17, the ink jet printer 1C is configured in the same manner as the ink jet printer 1 according to the first embodiment, except that a support column CY is provided to widely cover a transistor TrH, a transistor TrL, an inductor L0, and a part of a capacitor C0 in addition to the electrolytic capacitor Cd.

According to the present modification example, since the support column CY stably supports a communication substrate 600, it is possible to suppress a change in relative position and posture between a control substrate 500 and the communication substrate 600 in the ink jet printer 1C and to suppress the occurrence of a defect due to fretting corrosion.

In addition, according to the present modification example, the transistor TrH, the transistor TrL, and the inductor L0, which are electronic components that increase to a high temperature when the drive signal generation circuit 40 generates a drive signal Com, are covered by the support column CY, and thus, the electronic components that increase to a high temperature can be efficiently cooled as compared with an aspect in which the electronic components are not covered by the support column CY.

In the present modification example, a case is assumed where the inductor L0 covered by the support column CY includes a coil and a shield covering the coil. Accordingly, according to the present modification example, since the inductor L0 has a surface shape having less unevenness as compared with an aspect in which the inductor L0 does not include a shield, it is possible to reduce the possibility that a gap is generated between the support column CY and the inductor L0, and to implement a stable support of the communication substrate 600 by the support column CY. In addition, according to the present modification example, as compared with an aspect in which the inductor L0 does not include a shield, separation between silicone clay included in the support column CY and the inductor L0 is easily made, and reusability of the inductor L0 can be improved.

### Modification Example 2

In the first embodiment, the second embodiment, and the modification example 1 described above, an aspect in which the control substrate 500 (or the control substrate 500B) and the communication substrate 600 are coupled to each other by the substrate-to-substrate connector CN is exemplified and described, but the present disclosure is not limited to such an aspect. For example, the control substrate 500 (or the control substrate 500B) and the communication substrate 600 may be coupled to each other by a pin header. Here, the pin header is another example of a “coupling component”, and includes an insertion pin member having a plurality of insertion pins formed of metal and a holding portion that holds the plurality of insertion pins in a state of being insulated from each other, and a pin socket having a plurality of insertion holes provided to correspond to the plurality of insertion pins.

In the present modification example, a case is assumed where the insertion pin member of the pin header is fixed to a lower surface 5001 of the control substrate 500, and the pin socket of the pin header is fixed to an upper surface 6002 of the communication substrate 600. The pin header couples the control substrate 500 to the communication substrate 600 by fitting the insertion pin member to the pin socket, and signals are transmitted between the control substrate 500 and the communication substrate 600.

### Modification Example 3

In the first embodiment, the second embodiment, and the modification examples 1 and 2 described above, an aspect in which the support column CY includes heat conductive particles PT in addition to a base material SL configured with silicone clay is described as an example, but the present disclosure is not limited to such an aspect. The support column CY may be configured without including the heat conductive particles PT. For example, the support column CY may be silicone clay. In addition, for example, the support column CY may be configured with a clay-like material with an electrical insulation property other than silicone clay.

### Modification Example 4

In the first embodiment, the second embodiment, and the modification examples 1 to 3 described above, an ink jet printer and a smartphone are exemplified and described as an electronic device, but the present disclosure is not limited to such an aspect. An electronic device according to the present disclosure may be any electronic device having, for example, two or more circuit substrates, and may be an electronic device such as a digital camera or a projector, other than the ink jet printer and the smartphone. In this case, the first substrate may be a substrate provided in a main body of the electronic device, and the second substrate may be a substrate provided separately from the first substrate.

### D. Appendix

Aspects related to the above descriptions are additionally described below. In order to easily understand each aspect, hereinafter, reference signs of the drawings are given in parentheses for the sake of convenience, but the present disclosure is not limited to the illustrated aspects.

### D.1. Appendix 1

Hereinafter, an ink jet printer 1 related to Appendix 1 will be described.

Appendix 1-1

The ink jet printer 1 according to Appendix 1-1 includes the head unit 3 that forms an image on the recording paper PP based on the designation signal SI, the communication substrate 600 provided with the communication control circuit 62 that receives the image data Img indicating an image by wireless communication, the control substrate 500 provided with the drive control circuit 50 that generates the designation signal SI based on the image data Img, and the substrate-to-substrate connector CN that couples the communication substrate 600 to the control substrate 500, and the communication substrate 600 is supported on the control substrate 500 by a clay-like support column CY with an electrical insulation property.

According to the Appendix 1-1, the communication substrate 600 and the control substrate 500 are coupled to each other by the substrate-to-substrate connector CN, the communication substrate 600 is supported on the control substrate 500 by the support column CY, and thus, a change in relative position and posture between the communication substrate 600 and the control substrate 500 can be suppressed as compared with an aspect in which the support column CY is not provided. Accordingly, according to Appendix 1-1, it is possible to suppress a surface damage in the communication substrate 600 and the control substrate 500 which is caused by changes in relative positions and postures of the communication substrate 600 and the control substrate 500, and to reduce the possibility of occurrence of fretting corrosion caused by the surface damage in the communication substrate 600 and the control substrate 500.

### Appendix 1-2

An ink jet printer 1 according to Appendix 1-2 is the ink jet printer 1 according to Appendix 1-1, and includes the transport unit 9 including the belt 97 for transporting the head unit 3 and the medium transport mechanism 93 for transporting the recording paper PP, and the drive control circuit 50 controls the transport unit 9 and the head unit 3 such that the head unit 3 forms an image on the recording paper PP while the head unit 3 is transported by the belt 97.

According to Appendix 1-2, even when vibration occurs due to transport of the head unit 3 by the transport unit 9, the communication substrate 600 is supported by the support column CY, and thus, changes in relative positions and postures of the communication substrate 600 and the control substrate 500 can be suppressed.

### Appendix 1-3

An ink jet printer 1 according to Appendix 1-3 is the ink jet printer 1 according to Appendix 1-1 or Appendix 1-2, in which the communication substrate 600 has the lower surface 6001 supported by the support column CY and the upper surface 6002 opposite to the lower surface 6001, and the antenna 61 for performing wireless communication is provided on the upper surface 6002.

According to Appendix 1-3, it is possible to reduce the possibility that transmission and reception of signals in the antenna 61 are disrupted.

### Appendix 1-4

An ink jet printer 1 according to Appendix 1-4 is the ink jet printer 1 according to Appendix 1-1 to Appendix 1-3, in which the support column CY overlaps an electronic component included in the drive control circuit 50 when the communication substrate 600 is viewed in a plan view.

According to Appendix 1-4, as compared with an aspect in which the support column CY is provided not to overlap the electronic component, a height of the support column CY can be reduced, and the communication substrate 600 can be stably supported by the support column CY.

### Appendix 1-5

An ink jet printer 1 according to Appendix 1-5 is the ink jet printer 1 according to Appendix 1-1 to Appendix 1-4, in which the support column CY has thermal conductivity and includes the base material SL configured with silicone clay, and the heat conductive particles PT added to the base material SL.

According to Appendix 1-5, heat generated from the drive control circuit 50 provided on the control substrate 500 can be efficiently dissipated through the support column CY.

### Appendix 1-6

An ink jet printer 1 according to Appendix 1-6 is the ink jet printer 1 according to Appendix 1-1 to Appendix 1-4, and the support column CY is configured with silicone clay.

According to Appendix 1-6, a change in relative position and posture between the communication substrate 600 and the control substrate 500 can be suppressed.

### Appendix 1-7

An ink jet printer 1 according to Appendix 1-7 is the ink jet printer 1 according to Appendix 1-4, and an electronic component is the electrolytic capacitor Cd, such as an aluminum electrolytic capacitor.

According to Appendix 1-7, as compared with an aspect in which the support column CY is provided not to overlap the electrolytic capacitor Cd, a height of the support column CY can be reduced, and the communication substrate 600 can be stably supported by the support column CY. In addition, according to Appendix 1-7, since the support column CY is provided to overlap the electrolytic capacitor Cd having a simple shape compared with other electronic components, as compared with an aspect in which the support column CY is provided to overlap the other electronic components, the possibility that a gap is generated between the support column CY and the electrolytic capacitor Cd can be reduced, and the communication substrate 600 can be stably supported by the support column CY.

### Appendix 1-8

An ink jet printer 1 according to Appendix 1-8 is the ink jet printer 1 according to Appendix 1-4, and an electronic component is the inductor L0 covered with a shield.

According to Appendix 1-8, since the inductor L0 has a surface shape with less unevenness as compared with an aspect in which the inductor L0 does not include a shield, the possibility that a gap is generated between the support column CY and the inductor L0 can be reduced, and a stable support of the communication substrate 600 can be implemented by the support column CY. In addition, according to Appendix 1-8, as compared with the aspect in which the inductor L0 does not include the shield, separation between the support column CY and the inductor L0 can be easily made, and reusability of the inductor L0 can be increased.

### Appendix 1-9

An ink jet printer 1 according to Appendix 1-9 is the ink jet printer 1 according to Appendix 1-1 to Appendix 1-8, and is portable.

According to Appendix 1-9, even when vibration occurs due to the carrying of the ink jet printer 1, the communication substrate 600 is supported by the support column CY, and thus, changes in relative positions and postures of the communication substrate 600 and the control substrate 500 can be suppressed.

### Appendix 1-10

An ink jet printer 1 according to Appendix 1-10 is the ink jet printer 1 according to Appendix 1-1 to Appendix 1-9, and a color of the support column CY is different from at least one of a color of the communication substrate 600 and a color of the control substrate 500.

According to Appendix 1-10, since a workload of at least one of a work of separating the support column CY from the control substrate 500 and a work of separating the support column CY from the communication substrate 600 can be reduced, at least one of the control substrate 500 and the communication substrate 600 can be easily reused, and an environmental load of the ink jet printer 1 can be reduced.

### D.2. Appendix 2

Hereinafter, a smartphone 1B according to Appendix 2 will be described.

### Appendix 2-1

A smartphone 1B according to Appendix 2-1 includes the control substrate 500B, the communication substrate 600, and the substrate-to-substrate connector CN that couples the control substrate 500B to the communication substrate 600 and transmits electrical signals between the control substrate 500B and the communication substrate 600, and the communication substrate 600 is supported on the control substrate 500B by the clay-like support column CY with an electrical insulation property.

According to Appendix 2-1, the communication substrate 600 is coupled to the control substrate 500B by the substrate-to-substrate connector CN, and the communication substrate 600 is supported on the control substrate 500B by the support column CY, and thus, a change in relative position and posture between the communication substrate 600 and the control substrate 500B can be suppressed as compared with an aspect in which the support column CY is not provided. Accordingly, according to Appendix 2-1, it is possible to suppress surface damages of the communication substrate 600 and the control substrate 500B caused by changes in relative positions and postures of the communication substrate 600 and the control substrate 500B, and to reduce the possibility of fretting corrosion caused by the surface damages of the communication substrate 600 and the control substrate 500B.

### Appendix 2-2

A smartphone 1B according to Appendix 2-2 is the smartphone 1B according to Appendix 2-1, the communication substrate 600 includes the end region Ar1 including one end portion Eg1 of the communication substrate 600, the end region Ar2 including the other end portion Eg2 of the communication substrate 600, and the intermediate region Ar0 between the end region Ar1 and the end region Ar2 when the communication substrate 600 is viewed in a plan view, the substrate-to-substrate connector CN is coupled to the communication substrate 600 in the end region Ar1, and the support column CY supports the communication substrate 600 in the end region Ar2.

According to Appendix 2-2, the substrate-to-substrate connector CN is coupled to the communication substrate 600 in the end region Ar1, the support column CY supports the communication substrate 600 in the end region Ar2, and thus, the communication substrate 600 can be more stably supported on the control substrate 500B, as compared with an aspect in which one or both of the substrate-to-substrate connector CN and the support column CY are provided in the intermediate region Ar0.

### Appendix 2-3

A smartphone 1B according to Appendix 2-3 is the smartphone 1B according to Appendix 2-1 or Appendix 2-2, and the support column CY is provided at a position overlapping the electrolytic capacitor Cd provided on the control substrate 500B when the control substrate 500B is viewed in a plan view.

According to Appendix 2-3, as compared with an aspect in which the support column CY is provided not to overlap the electrolytic capacitor Cd, a height of the support column CY can be reduced, and the communication substrate 600 can be stably supported by the support column CY.

### Appendix 2-4

A smartphone 1B according to Appendix 2-4 is the smartphone 1B according to Appendix 2-3, and the electrolytic capacitor Cd is larger than other electronic components provided at a position of the control substrate 500B that does not overlap the support column CY when the control substrate 500B is viewed in a plan view.

According to Appendix 2-4, as compared with an aspect in which the electrolytic capacitor Cd is smaller than the other electronic components, a height of the support column CY can be reduced, and the communication substrate 600 can be stably supported by the support column CY.

### Appendix 2-5

A smartphone 1B according to Appendix 2-5 is the smartphone 1B according to Appendix 2-3, and the support column CY is provided at a position overlapping the communication control circuit 62 provided on the communication substrate 600 when the communication substrate 600 is viewed in a plan view.

According to Appendix 2-5, as compared with an aspect in which the support column CY is provided not to overlap the communication control circuit 62, a height of the support column CY can be reduced, and the communication substrate 600 can be stably supported by the support column CY.

### Appendix 2-6

A smartphone 1B according to Appendix 2-6 is the smartphone 1B according to Appendix 2-1 to Appendix 2-5, and the support column CY includes the base material SL that has thermal conductivity and is configured with silicone clay, and the heat conductive particles PT added to the base material SL.

According to Appendix 2-6, the heat generated from the drive control circuit 50B provided on the control substrate 500B can be efficiently dissipated through the support column CY.

### Appendix 2-7

A smartphone 1B according to Appendix 2-7 is the smartphone 1B according to Appendix 2-1 to Appendix 2-5, and the support column CY is configured with silicone clay.

According to Appendix 2-7, it is possible to suppress a change in relative position and posture between the communication substrate 600 and the control substrate 500B.

### Appendix 2-8

A smartphone 1B according to Appendix 2-8 is the smartphone 1B according to Appendix 2-1 to Appendix 2-7, and is portable.

According to Appendix 2-8, even when vibration occurs due to the carrying of the smartphone 1B, the communication substrate 600 is supported by the support column CY, and thus, it is possible to suppress changes in relative positions and postures of the communication substrate 600 and the control substrate 500B.

### Appendix 2-9

A smartphone 1B according to Appendix 2-9 is the smartphone 1B according to Appendix 2-1 to Appendix 2-8, the communication substrate 600 has one side of 1 inch or less, and the communication control circuit 62 that performs wireless communication is provided on the communication substrate 600.

According to Appendix 2-9, even when vibration occurs in the smartphone 1B, a size of the communication substrate 600 supported by the support column CY is small, and thus, it is possible to suppress changes in relative positions and postures of the communication substrate 600 and the control substrate 500B.

What is claimed is:

1. A printing apparatus comprising:
a print head configured to form an image on a medium based on a control signal;
a communication substrate provided with a communication circuit that receives image information indicating the image by wireless communication;
a control substrate provided with a control circuit that generates the control signal based on the image information; and
a coupling component configured to couple the communication substrate to the control substrate, wherein the communication substrate is supported on the control substrate by a clay-like support column with an electrical insulation property.

2. The printing apparatus according to claim 1, further comprising:
a transport mechanism including a head transport mechanism configured to transport the print head and a medium transport mechanism configured to transport the medium, wherein
the control circuit controls the transport mechanism and the print head such that the print head forms the image on the medium while the print head is transported by the transport mechanism.

3. The printing apparatus according to claim 1, wherein
the communication substrate has a first surface supported by the support column and a second surface opposite to the first surface, and
an antenna for performing wireless communication is provided on the second surface.

4. The printing apparatus according to claim 1, wherein
the support column is provided at a position overlapping an electronic component included in the control circuit when the control substrate is viewed in a plan view.

5. The printing apparatus according to claim 1, wherein
the support column has thermal conductivity and includes a base material configured with silicone clay, and heat conductive particles added to the base material.

6. The printing apparatus according to claim 1, wherein
the support column is configured with silicone clay.

7. The printing apparatus according to claim 4, wherein
the electronic component is an aluminum electrolytic capacitor.

8. The printing apparatus according to claim 4, wherein
the electronic component is an inductor covered with a shield that blocks magnetism.

9. The printing apparatus according to claim 1, wherein
the printing apparatus is portable.

10. The printing apparatus according to claim 1, wherein
a color of the support column is different from at least one of a color of the communication substrate and a color of the control substrate.

11. An electronic device comprising:
a drive device driven based on a control signal;
a communication substrate provided with a communication circuit that receives instruction information on an operation of the drive device by wireless communication;
a control substrate provided with a control circuit that generates the control signal based on the instruction information; and
a coupling component configured to couple the communication substrate to the control substrate, wherein the communication substrate is supported on the control substrate by a clay-like support column with an electrical insulation property.

12. The electronic device according to claim 11, wherein
the drive device has a displacement portion that changes a relative position or a relative posture with respect to the electronic device when the drive device is driven.

13. The electronic device according to claim 11, wherein
the communication substrate has a first surface supported by the support column and a second surface opposite to the first surface, and
an antenna for performing wireless communication is provided on the second surface.

14. The electronic device according to claim 11, wherein
the support column is provided at a position overlapping an electronic component included in the control circuit when the control substrate is viewed in a plan view.

15. The electronic device according to claim 11, wherein
the support column has thermal conductivity and includes a base material configured with silicone clay, and heat conductive particles added to the base material.

16. The electronic device according to claim 11, wherein
the support column is configured with silicone clay.

17. The electronic device according to claim 14, wherein
the electronic component is an aluminum electrolytic capacitor.

18. The electronic device according to claim 14, wherein
the electronic component is an inductor covered with a shield that blocks magnetism.

19. The electronic device according to claim 11, wherein
the electronic device is portable.

20. The electronic device according to claim 11, wherein
a color of the support column is different from at least one of a color of the communication substrate and a color of the control substrate.
